(19) United States
(12) Patent Application Publication
(10) Pub. No.: US 2016/0035487 A1
(43) Pub. Date: Feb. 4, 2016

(54) MNBI-BASED MAGNETIC SUBSTANCE, PREPARATION METHOD THEREOF, MNBI-BASED SINTERED MAGNET AND PREPARATION METHOD THEREOF

(71) Applicant: LG ELECTRONICS INC., Seoul (KR)

(72) Inventors: Jinbae KIM, Seoul (KR); Yangwoo BYUN, Seoul (KR)

(73) Assignee: LG ELECTRONICS INC., Seoul (KR)

(21) Appl. No.: 14/741,105

(22) Filed: Jun. 16, 2015

(30) Foreign Application Priority Data
Jul. 29, 2014 (KR) 10-2014-0096687

(51) Int. Cl. H01F 41/02; C22C 12/00; C22C 1/04; H01F 1/08; B22F 3/12; B22F 9/04; H01F 1/047; C22F 1/16; C22C 1/02

(52) U.S. Cl. CPC H01F 41/0266; C22F 1/16; C22C 12/00; C22C 1/04; C22C 1/02; B22F 3/12; B22F 9/04; H01F 1/047; H01F 1/086; B22F 2009/043

(57) ABSTRACT

The method of preparing an MnBi-based magnetic substance according to the present invention includes: (a) preparing a mixed melt by simultaneously melting a manganese-based material and a bismuth-based material; (b) forming a non-magnetic MnBi-based ribbon by cooling the mixed melt; and (c) converting the non-magnetic MnBi-based ribbon into a magnetic MnBi-based ribbon by performing a heat treatment. The method for preparing an MnBi-based sintered magnet includes: (a) preparing a magnetic powder by pulverizing the MnBi-based magnetic substance; (b) molding the magnetic powder in a state where a magnetic field is applied; and (c) sintering the molded magnetic powder.

### CROSS-REFERENCE TO RELATED APPLICATION

This application claims priority from and the benefit under 35 U.S.C. §119(a) of Korean Application No. 10-2014-0096687, filed on Jul. 29, 2014, the contents of which is incorporated by reference herein in its entirety.

### BACKGROUND OF INVENTION

1. Field of the Invention

The present invention relates to a method for preparing an MnBi-based magnetic substance through rapid cooling and a low-temperature heat treatment, an MnBi-based magnetic substance having excellent magnetic characteristics obtained by the preparation method, an MnBi-based sintered magnet suitable for a device driven with high temperature heat resistant characteristics, and a preparation method thereof.

2. Background of Invention

The low-temperature phase (LTP) MnBi, which exhibits ferromagnetic characteristics, is a permanent magnet formed of rare earth-free materials. The coercivity of the LTP MnBi has a positive temperature coefficient at a temperature between −123 to 277° C. Thus, the LTP MnBi has a coercivity larger than that of a Nd₂Fe₁₄B permanent magnet at a temperature of 150° C. or higher.

Accordingly, the LTP MnBi is a material suitable for a motor driven at high temperatures (100 to 200° C.). Using the (BH)max value to compare the magnetic performance index, the LTP MnBi exhibits a better performance than the conventional ferrite permanent magnet, and may exhibit a performance equivalent to or more than that of a rare earth Nd₂Fe₁₄B bond magnet. Thus, the LTP MnBi is a material which may replace these magnets.

However, it is difficult to prepare a single phase LTP MnBi by conventional general synthesis methods. Since the difference in the melting point between Mn and Bi is about 975° C. or higher, it is difficult to prepare an ingot. Also, a heat treatment process needs to be performed at 340° C. or less, which is a relatively low temperature for preparing the single phase LTP MnBi. As a consequence, a problem arises when Mn atoms are separated due to the slow diffusion reaction of Mn in a peritectic reaction. For these reasons, it has been difficult to prepare the single phase LTP MnBi.

### SUMMARY OF INVENTION

An object of the present invention is to provide an MnBi-based magnetic substance having excellent magnetic characteristics from two metals having a large difference in melting point through a method such as simultaneous melting and rapid cooling, a preparation method thereof, a method for preparing an MnBi-based sintered magnet by using the same, and an MnBi-based sintered magnet having excellent magnetic characteristics at high temperatures.

To achieve these and other advantages and in accordance with the purpose of the present invention, as embodied and broadly described herein, the present invention provides, a method for preparing an MnBi-based magnetic substance according to an exemplary embodiment of the present invention includes: (a) simultaneously melting a manganese-based material and a bismuth-based material to prepare a mixed belt; (b) cooling the mixed melt to form a non-magnetic MnBi-based ribbon; and (c) performing a heat treatment to convert the non-magnetic MnBi-based ribbon into a magnetic MnBi-based ribbon.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The patent or application filed contains at least one drawing executed in color. Copies of this patent or patent application publication with color drawings will be provided by the office upon request and payment of the necessary fee.

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a flow chart schematically illustrating a process of preparing an MnBi-based magnetic substance and an MnBi-based sintered magnet according to an exemplary embodiment of the present invention.

FIG. 2 is a schematic view illustrating a change in size of Mn crystals depending on the cooling speed of a mixed melt of Mn and Bi.

FIG. 3A is a scanning electron microscope (SEM) image showing the distribution and crystal sizes of Mn, Bi, and MnBi phases depending on the cooling speed of a mixed melt of Mn and Bi when the wheel speed is 37 m/s. FIG. 3B is a SEM image showing the distribution and crystal sized of Mn, Bi, and MnBi phases depending on the cooling speed of a mixed melt of Mn and Bi when the wheel speed is 65 m/s.

FIG. 4 is an X-ray diffraction analysis (XRD) showing the crystallinity of Mn, Bi, and MnBi phases depending on the cooling speed of the mixed melt of Mn and Bi.

FIG. 5 is a magnetic hysteresis curve illustrating magnetic characteristics of the MnBi-based magnetic substance depending on the cooling speed and low-temperature heat treatment time of the mixed melt of Mn and Bi.

FIG. 6 is a graph illustrating magnetic characteristics of the MnBi-based sintered magnet depending on the milling time of the MnBi-based magnetic substance.

FIG. 7 is a graph illustrating magnetic characteristics of the MnBi-based sintered magnet at normal temperature (about 25° C.) and high temperature (about 150° C.).

FIG. 8 is a graph illustrating magnetic characteristics of the conventional MnBi-based permanent magnet depending on the temperature.

### DETAILED DESCRIPTION OF INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, exemplary embodiments of the present invention will be described in detail with reference to accompanying drawings, such that those skilled in the art to which the present invention pertains can easily carry out the present invention. However, the present invention can be implemented in various different forms, and is not limited to the exemplary embodiments described herein.

The term “MnBi low-temperature phase” as used herein refers to a phase produced at a relatively lower temperature than the eutectic point of Mn and Bi, and may mean a ferromagnetic phase because the MnBi low-temperature phase generally has stronger magnetic characteristics than a phase produced at a temperature which is equivalent to or greater than the eutectic point.

The term “low-temperature heat treatment” as used herein means a heat treatment performed in a temperature range at which the MnBi low-temperature phase may be produced, and may mean, a heat treatment performed at about 400° C. or less, a heat treatment in a temperature range that smoothly diffuses the magnetic phase and prevents crystal particles from coarsening.

Hereinafter, the present invention will be described in more detail.

The method for preparing an MnBi-based magnetic substance according to an exemplary embodiment of the present invention includes: (a) melting a manganese-based material to prepare a mixed melt; (b) cooling the mixed melt to form a non-magnetic phase Mm-Bi-based ribbon; and (c) performing a heat treatment to convert the non-magnetic MnBi-based ribbon into a magnetic MnBi-based ribbon.

The mixed melt in step (a) may be prepared by mixing a manganese-based material and a bismuth-based material, and then rapidly heating and melting the resulting mixture.

The manganese-based material and the bismuth-based material may be a powder phase. The manganese-based material may include manganese (Mn) and may generally be a solid powder of a manganese metal The bismuth-based material may include bismuth (Bi) and may generally be a solid powder of a bismuth metal.

The melting in step (a) may be performed at a temperature of 1,200° C. or higher. The melting point of Mn is 1,246° C. and the melting point of Bi is about 271.5° C. A temperature of about 1,200° C. or higher is required to simultaneously melt the two metals. The melting method applied includes, for example, an induction heating process, an arc-melting process, a mechanochemical process, a sintering process, a combination thereof. The melting method may be a rapid cooling process including these methods.

The non-magnetic MnBi-based ribbon in step (b) may be formed by cooling the mixed melt in step (a).

The cooling in step (b) may be a rapid cooling process, and the rapid cooling process may include, for example, a rapid solidification process (RSP), an atomizer process, and a combination thereof.

The difference in melting point between Mn and Bi is large enough that crystals with a significantly large size may be formed when the cooling speed is not significantly increased. When the crystal size is large, a smooth diffusion reaction may not occur during a subsequently performed low-temperature heat treatment.

Thus, a rapid solidification process (RSP) may be preferred as the rapid cooling process of increasing the cooling speed. The rapid solidification process may have a wheel speed of 55 to 75 m/s, preferably 60 to 70 m/s. When the wheel speed is less than 55 m/s, Mn crystals inside the non-magnetic MnBi-based ribbon may be formed that have a significantly large size. As described above, the distribution of Mn, Bi, and MnBi phases is not uniform, and thus Mn atoms may not smoothly diffuse in a low-temperature heat treatment step where a subsequent peritectic reaction occurs. Accordingly, magnetic characteristics may be inferior due to the failure in the formation of the ferromagnetic phase MnBi low-temperature phase. When the wheel speed exceeds 75 m/s, there is a risk that the minimum crystals for converting the non-magnetic phase into the magnetic phase may not be formed, and an amorphous ribbon is formed, and thus magnetic characteristics may not be exhibited.

That is, when the wheel speed of the rapid solidification process is set at 55 to 75 m/s, Mn, Bi, and MnBi phases with a nano-scale crystal size may be formed and the three phases may be uniformly distributed. Accordingly, an MnBi-based ribbon may be formed in a state where Mn, and the like, may easily diffuse during the low-temperature heat treatment.

Bi crystals inside the non-magnetic MnBi-based ribbon formed by step (b) may have a size of about 100 nm or less.

The magnetic MnBi-based ribbon in step (c) may be converted from a non-magnetic MnBi-based ribbon by performing a heat treatment.

The heat treatment in step (c) may be performed at a temperature of 280 to 340° C., preferably 300 to 320° C. and under a high vacuum pressure of 5 mPa or less. Such a heat treatment may be performed through a process called a low-temperature heat treatment, and a peritectic reaction where Mn crystals diffusion occurs. Accordingly, the MnBi low-temperature phase (LTP) may be formed, and the MnBi-based ribbon may have magnetic characteristics because the single phase MnBi low-temperature phase is ferromagnetic.

The heat treatment in step (c) may be performed for 2 to 5 hours, preferably 3 to 4 hours, and the heat treatment induces diffusion of Mn included in the non-magnetic MnBi-based ribbon, and may include a low-temperature heat treatment process which forms the MnBi low-temperature phase.

According to conventional methods, the difference in the melting point between Mn and Bi is large enough that Mn is first precipitated during cooling. Accordingly, phases are non-uniformly distributed inside the formed MnBi-based ribbon, and the crystal size of Mn is also significantly large. Further, the metal first precipitated is solidified in a shape which surrounds the metal which is later precipitated, thereby making it difficult for Mn to diffuse during the low-temperature heat treatment. Also, since the heat treatment is performed at low temperature, a long-term heat treatment exceeding almost 24 hours is required for Mn to sufficiently diffuse.

However, in the present invention, significantly small size crystals such as Mn and Bi may be formed through rapid cooling. Accordingly, even though the low-temperature heat treatment is performed for only about 2 to 5 hours, Mn may sufficiently diffuse. As a result, it is possible to prepare an MnBi-based ribbon having excellent magnetic characteristics due to the smooth formation of the MnBi low-temperature phase. Furthermore, the time may also be significantly reduced, even though the heat treatment is also performed at a low temperature. Thus, it is also possible to prevent a coarsening phenomenon in which crystal grains grow and become fused with each other and increase the size of crystal grains Additionally, it is possible to obtain an energy-saving effect.

The MnBi-based magnetic substance according to another exemplary embodiment of the present invention is a single phase MnBi-based magnetic substance, which has a Bi crystal average size of 100 nm or less, includes an MnBi phase and a Bi-rich phase, and may be prepared by the above-described preparation method.

The MnBi-based magnetic substance may have an atomic ratio of Mn and Bi of 3:7 to 7:3. If the ratio of Mn and Bi is reduced to less than 3.7, and thus having a decreased content of Mn, there is a risk of deterioration in the magnetic characteristics of the MnBi-based magnetic substance because there may be reduced formation of the low-temperature phase MnBi due to diffusion of Mn. Also, if the ratio of Mn and Bi is increased to more than 7.3, there is a risk of deterioration in the magnetic characteristics of the MnBi-based magnetic substance because there may be reduced formation of the low-temperature phase MnBi due to diffusion of Mn.

The MnBi-based magnetic substance may include 90% or more, and more preferably 95% or more, of the MnBi low-temperature phase (LTP). When the MnBi low-temperature phase is included in an amount of about 90% or more as a content of the MnBi low-temperature phase, such that the MnBi-based magnetic substance exhibits minimum magnetic characteristics, the MnBi-based magnetic substance may exhibit excellent magnetic characteristics. Since other characteristics of the MnBi-based magnetic substance are the same as the above-described content, the description thereof will be omitted.

The method for preparing an MnBi-based sintered magnet according to another exemplary embodiment of the present invention includes: (a) pulverizing the above-described MnBi-based magnetic substance to prepare a magnetic powder; (b) molding the magnetic powder in a state where a magnetic field is applied; and (c) sintering the molded magnetic powder.

The magnetic powder in step (a) may be prepared by pulverizing the ribbon-type MnBi-based magnetic substance. Pulverization may be performed by any method, including ball milling. However, the pulverization method is not limited to ball milling, and pulverization may also be performed by using an apparatus, such as a grinder, a microfluidizer and a homogenizer.

Ball milling may be performed for 2 to 5 hours, preferably 3 to 4 hours, and may be performed while the ball and the MnBi-based magnetic substance are mixed at a ratio of 1:15 to 1:45, preferably 1:25 to 1:35, and Φ5 and Φ10 in blending of the ball may be 1:3 to 1:7.

At the time of ball milling, the ratio of the ball and the magnetic substance, and the blending of the ball, and physical shapes are modified from the ribbon form into the powder form, while magnetic characteristics of the MnBi-based magnetic substance are maintained as maximally as possible. When the milling conditions as described above are satisfied, the remnant magnetic flux density, coercivity, and maximum energy product of the MnBi-based magnetic substance may be maintained when they are compared to those values prior to the milling. When the milling time exceeds 5 hours, Mn begins to oxidize and forms MnO, thereby leading to a risk that magnetic characteristics may be lost.

Through the milling as described above, the ribbon-type MnBi-based magnetic substance may have a powder particle size of 0.5 to 5 μm, preferably about 1 to 3 μm when the magnetic substance becomes a magnetic powder. That is, the powder particle size may be a single magnetic domain size, slightly larger or slightly smaller than the single magnetic domain size.

The magnetic powder in step (a) may be molded into a in step (b) to be a molded article having a specific form.

In this case, the magnetic powder may be molded while a magnetic field is concurrently applied, the magnetization directions of magnetic domains inside the powder particle may be aligned in one direction, thereby imparting magnetic characteristics as a permanent magnet. Accordingly, the magnetic field to be applied may be at an intensity of 1 to 5 T, preferably 1 to 2 T. When a magnetic field with a small intensity of less than 1 T is applied, the magnetization direction may not be aligned, and when the magnetic field has an intensity of more than 5 T, more energy than is required is consumed, which is wasteful.

The permanent magnet in step (c) may be made by sintering the molded article prepared in step (b).

The sintering in step (c) may be performed by a rapid sintering method in which the sintering is rapidly conducted, and the sintering temperature may be about 200 to 300° C. The sintering may be performed by using a hot press device in a vacuum state, and the molded article in the device may be compressed under a pressure of approximately 100 to 500 MPa. The compression may be simultaneously performed with heating at the temperature for a short period of time, for example, about 1 minute to 10 minutes.

According to still another exemplary embodiment of the present invention, the MnBi-based sintered magnet has an atomic ratio of Mn and Bi of 3:7 to 7:3, includes 90% or more of the MnBi low-temperature phase (LTP), and may be prepared by the above-described preparation method.

For the MnBi-based sintered magnet, the magnetic characteristics of the magnetic powder itself may be enhanced by applying a rapid cooling method, such as RSP and a heat treatment method, such LTP, and the like. These methods are different from conventional methods for preparing the MnBi-based magnetic substance. Accordingly, it is possible to obtain a MnBi-based sintered magnet having coercivity and remnant magnetic flux density, which are better than those of conventional permanent magnets. In addition, since the value of the maximum energy product, which is a measure that indicates energy which the permanent magnet may consume, may be better than those of conventional rare earth-based permanent magnets or ferrite-based permanent magnets, and the like, the MnBi-based sintered magnet may replace rare earth-based permanent magnets as rare earth-free permanent magnets.

Furthermore, the MnBi-based sintered magnet may have heat resistant characteristics. The heat resistant characteristics may mean that the values of coercivity, remnant magnetic flux density, and maximum energy product values are 90% or more compared to values at 15 to 30° C. or more, which is a normal temperature. The MnBi-based sintered magnet of the present invention may have these heat resistant characteristics.

A rare earth-based permanent magnet, such as the conventional neodymium-based bond magnet and a ferrite-based sintered magnet, failed to be applied to a device which is driven at high temperature because magnetic characteristics thereof at high temperature were reduced by 30% or less than those at normal temperature.

However, since the change in magnetic characteristics between normal temperature and high temperature is 10% or less for the MnBi-based sintered magnet of the present invention, there is no significant change in magnetic characteristics. Accordingly, when the MnBi-based sintered magnet is applied to a device which is driven at high temperature (e.g., a motor for a refrigerator and an air conditioner compressor, a washing machine driving motor, a speaker, automobile electronics parts and the like), enhanced performance and service life of the device itself may be obtained.

The MnBi-based magnetic substance of the present invention may have excellent magnetic characteristics by suppressing Mn crystal growth through a rapid cooling, such as RSP, as the only heat treatment for a considerably short period of time compared to a related art magnetic substance. When an MnBi-based sintered magnet is prepared by using the same, it is possible to obtain an MnBi-based sintered magnet which has better magnetic characteristics compared to a related art permanent magnet and with no significant change in magnetic characteristics, particularly at high temperature even compared to magnetic characteristics at normal temperature. Thus, it may be advantageously applied to a device which is driven at high temperature, which is highly industrially applicable as a permanent magnet and may replace a rare earth-based permanent magnet.

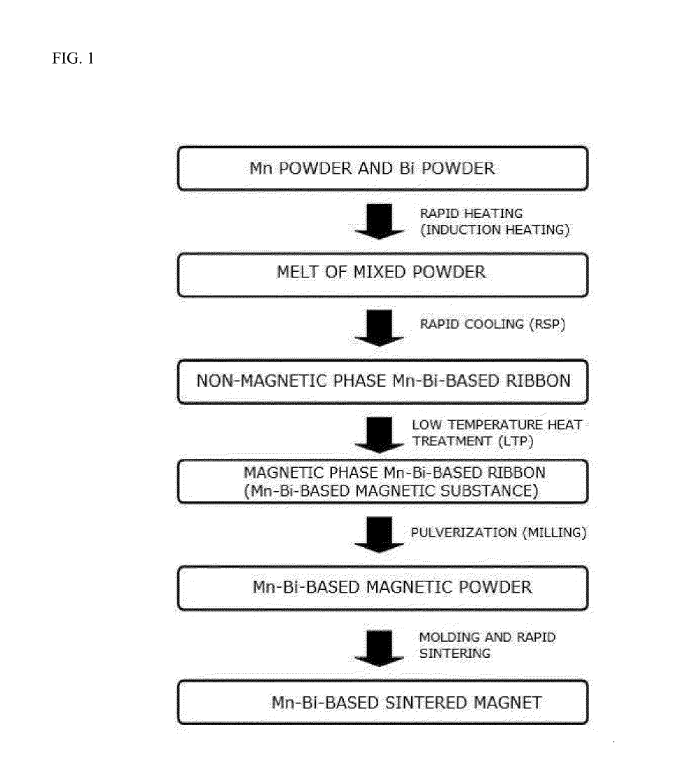

Next, FIG. 1 illustrates the outline of the method for preparing an MnBi-based magnetic substance and an MnBi-based sintered magnet according to the present invention as a flow chart. First, a powder of Mn and Bi is mixed, a melt is formed by melting the resulting mixture through rapid heating, and then a non-magnetic MnBi-based ribbon is again prepared through a rapid cooling using a method such as RSP. Moreover, an MnBi-based magnetic substance is prepared by performing a low-temperature heat treatment (LTP) in order to impart magnetic properties, and converting the non-magnetic phase into the magnetic phase. Subsequently, an MnBi-based magnetic powder is prepared by pulverizing the magnetic substance using a method such as milling, and then an MnBi-based sintered magnet is prepared through molding and rapid sintering.

Hereinafter, the process of preparing the MnBi-based magnetic substance and the MnBi-based sintered magnet as described above will be described in detail through the Examples.

### EXAMPLES

### Example 1

### Preparation of MnBi-Based Magnetic Substance

1) Preparation of Mixed Melt

First, a manganese (Mn) metal powder and a bismuth (Bi) metal powder were mixed, and the resulting mixture powder was placed into a furnace, and then molten through an induction heating method. That is, a mixed melt was prepared by instantaneously raising the temperature of the furnace to 1,400° C.

2) Preparation of Non-Magnetic MnBi-Based Ribbon

The mixed melt was slowly injected into a wheel of which a wheel speed was set to about 37 m/s and about 65 m/s, respectively, to prepare a non-magnetic MnBi-based ribbon in a solid state by cooling the mixed melt through an air-cooling system when the mixed melt was released from the wheel by force which rotated the wheel.

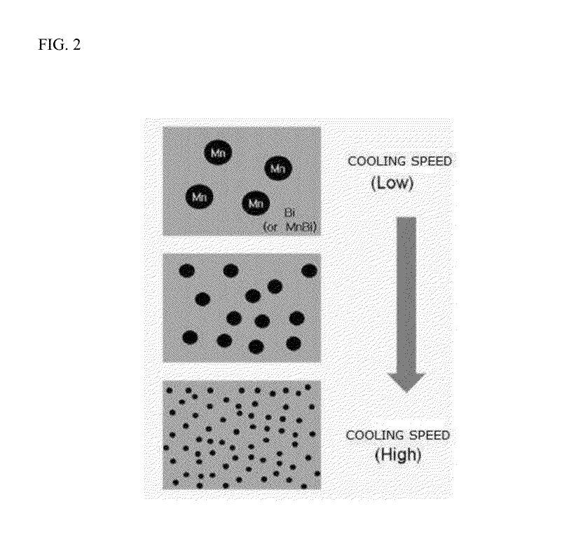

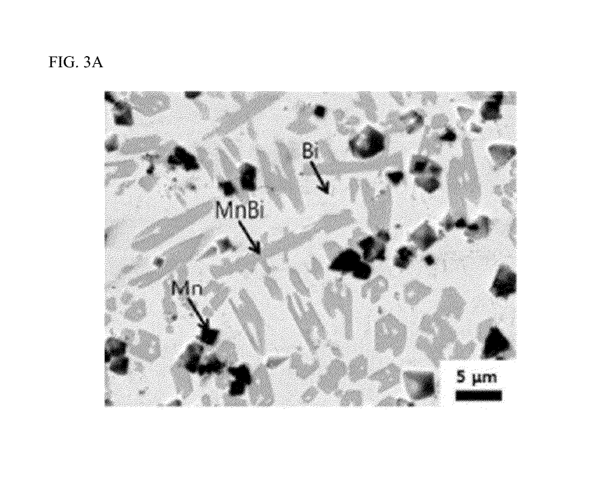

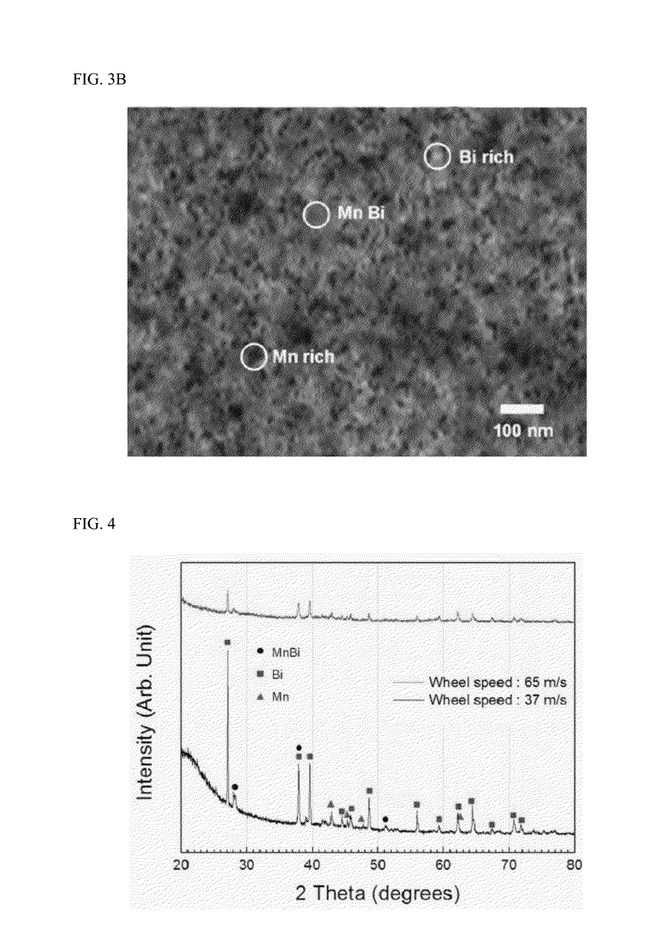

The size of Bi crystals inside the prepared non-magnetic MnBi-based ribbon was measured for each wheel speed. The result is shown in the following Table 1. A change in Mn, Bi, and MnBi crystals for each wheel speed is illustrated in a schematic view in FIG. 2. The crystals were photographed by an electron microscope and the distribution thereof is illustrated in FIGS. 3A and 3B. Further, each MnBi-based ribbon was measured by XRD, and the results are illustrated in FIG. 4.

TABLE 1

| Wheel Speed (m/s) | Bi Average Crystal Size (nm) |
|---|---|
| 37 | 250 |
| 65 | 45 |

FIG. 2 illustrates the trend of smaller manganese crystals as cooling speed becomes higher. FIG. 2 schematically illustrates that the size of crystal grains is suppressed through a rapid cooling. When the size of the crystal grains is small, manganese may easily diffuse in a subsequently performed heat treatment, thereby preparing a magnetic powder having excellent magnetic properties.

Based on FIG. 2, the wheel speed was adjusted in Example 1-2) in order to increase the cooling speed, and accordingly, the size, degree of distribution, and crystallinity, and the like of the crystals are illustrated. Referring to FIG. 3A, when a wheel speed was set to 37 m/s, the size of manganese crystals (black) was significantly large, the distribution was also non-uniform. It was confirmed that the MnBi phase and Bi were also sparsely distributed in a non-uniform size. However, FIG. 3B confirmed that when the phases were rapidly cooled at a speed of 65 m/s, Mn crystals were uniformly distributed in a significantly small size. It could also be confirmed that the Mn—Bi phase or Bi and Mn crystals were also small in size and the distribution thereof was uniform, and this result is the same as the size of Bi crystals according to the wheel speed shown in Table 1.

In addition, referring to FIG. 4, when a wheel speed was 37 m/s, the peak of crystals did not almost appear, whereas when the wheel speed was 65 m/s, a considerable number of peaks were shown. Thus, it was confirmed that when the mixed melt was cooled at a wheel speed of 65 m/s, the crystallinity was excellent. Also, it was confirmed through the comparison of relative intensities that the result was the same as the crystal size shown in Table 1.

As described above, through the results, it was confirmed that as the wheel speed was increased, (i.e., as the cooling speed was increased), the size of the Mn crystal grains was suppressed. In addition, the size of the MnBi phase or Bi crystals was similarly suppressed. Accordingly, the three phases as a whole was uniformly distributed inside the ribbon.

3) Preparation of Magnetic MnBi-Based Ribbon

In order to impart magnetic properties to the non-magnetic MnBi-based ribbon prepared in 2), a low-temperature heat treatment was performed at a temperature of 320° C. and under vacuum conditions. A magnetic MnBi-based ribbon was formed by performing a heat treatment for 3 hours and 24 hours, respectively, according to a wheel speed to induce the diffusion of Mn included in the non-magnetic MnBi-based ribbon. The MnBi-based magnetic substance was prepared by this process.

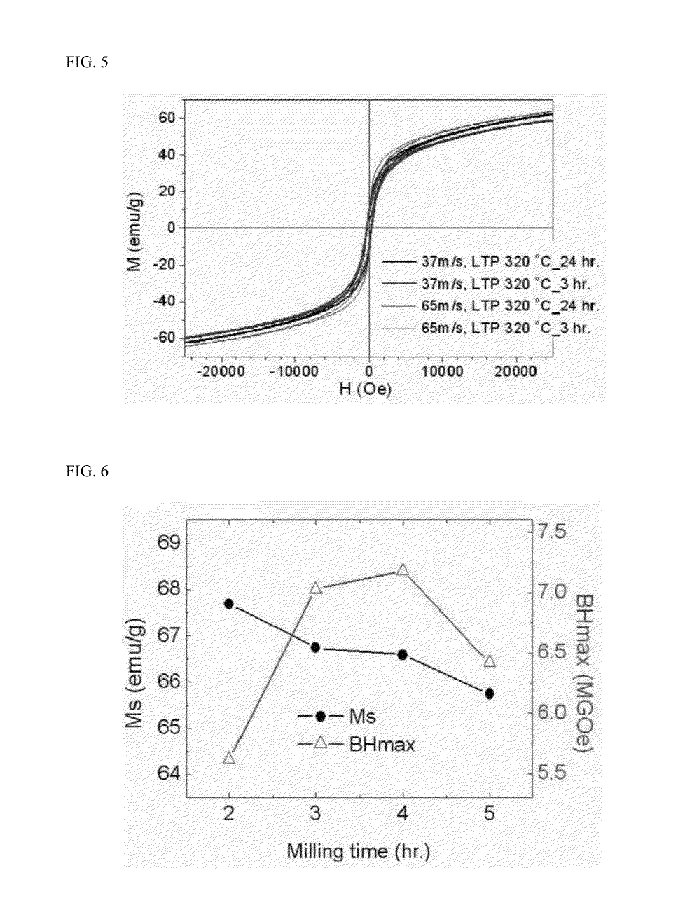

The remnant magnetic flux density and coercivity of the MnBi-based magnetic substance prepared through the 1) to 3) processes were measured by using a vibrating sample magnetometer (VSM, Lake Shore #7300 USA, maximum 20 kOe). A magnetic hysteresis curve is illustrated in FIG. 5. The values are shown in the following Table 2.

TABLE 2

Treatment conditions

| Wheel speed (m/s) | Time (hr) | Ms (emu/g) | Hc (kOe) |
|---|---|---|---|
| 37 | 3 | 59.4 | 0.32 |
| | 24 | 62.5 | 0.30 |
| 65 | 3 | 64.1 | 0.30 |
| | 24 | 59.5 | 0.37 |

Referring to Table 2 and FIG. 5, when a wheel speed was 65 m/s, a high value from the remnant magnetic flux density was shown, even though the low-temperature heat treatment was performed for only a short period of time of 3 hours. When the cooling speed was fast, manganese crystal grains with a small size were formed, and the manganese crystals or bismuth and MnBi phases was uniformly distributed. Thus, it was confirmed through a smooth diffusion reaction that a magnetic MnBi-based ribbon with improved coercivity and remnant magnetic flux density values was formed.

### Example 2

### Preparation of MnBi-Based Sintered Magnet

A process of making a powder using a ball milling was performed on an MnBi-based magnetic substance having a wheel speed of 65 m/s and a heat treatment time of 3 hours among the MnBi-based magnetic substances prepared in Example 1. The process of making a powder was performed for 2, 3, 4, and 5 hours, respectively. The ratio of the magnetic phase ribbon (MnBi-based magnetic substance) and the ball was about 1:30, and Φ5 and Φ10 in ball blending were set to about 1:5. Subsequently, the magnetic powder prepared by the ball milling was molded under a magnetic field of about 1.6 T, and then an MnBi-based sintered magnet was prepared by performing a rapid sintering at about 260° C. for 3 minutes using a hot press in a vacuum state.

For the MnBi-based sintered magnet prepared for each of the times performed for the milling processes, the maximum energy product, coercivity, and remnant magnetic flux density were measured for evaluating magnetic characteristics, and the results are shown in the following Table 3 and FIG. 6.

TABLE 3

| Milling time (hr) | Ms (emu/g) | Hc (kOe) | BHmax (MGOe) |
|---|---|---|---|
| 2 | 67.7 | 2.0 | 5.6 |
| 3 | 66.7 | 3.1 | 7.0 |
| 4 | 66.6 | 3.1 | 7.2 |
| 5 | 65.7 | 3.1 | 6.4 |

Referring to Table 3 and FIG. 6, as the time for performing the milling process is gradually increased, the remnant magnetic flux density values are gradually decreased. This confirms that the internal manganese is oxidized and loses its magnetic properties, while a ribbon-type MnBi-based magnetic substance becomes a powder by milling, and a milling time of 3 to 4 hours indicates a value in which the maximum energy product has been improved It is preferred to perform the milling for approximately 3 to 4 hours because this time point exhibits a reduced remnant magnetic flux density and the maximum energy product becomes a maximum value.

However, the milling time is not limited to 3 to 4 hours since the maximum energy product indicates a value higher than that of the conventional permanent magnet, such as a neodymium-based sintered magnet and a ferrite magnet, both in the case where the milling was performed for 2 hours and for 5 hours.

Experimental Example: Evaluation of High Temperature Magnetic Characteristics of MnBi-Based Sintered Magnet

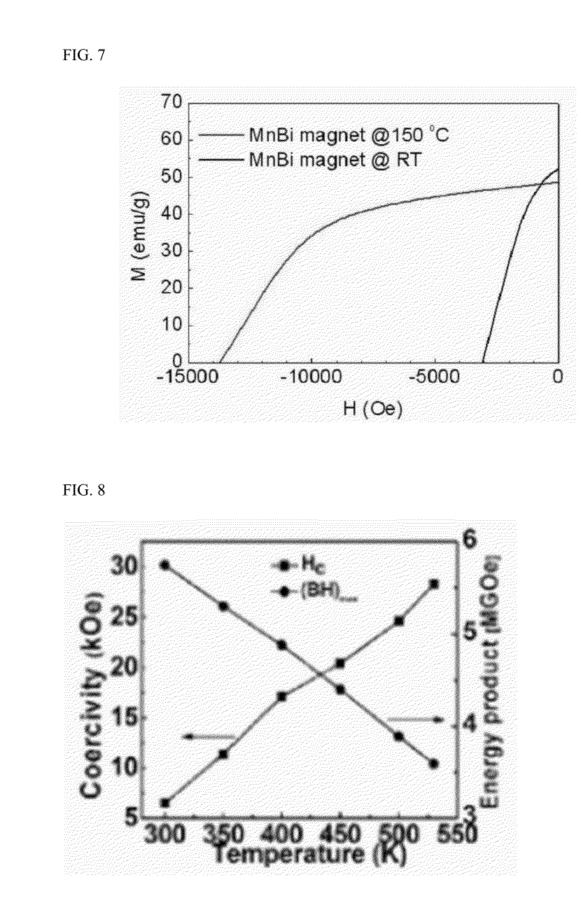

In order to evaluate magnetic properties of an MnBi-based sintered magnet (a wheel speed of 65 m/s, a low-temperature heat treatment of 3 hours, and a milling of 4 hours) prepared through Examples 1 and 2, and an MnBi-based permanent magnet ([1]) prepared by subjecting an MnBi-based ingot prepared by an arc-melting as the Comparative Example to low-temperature heat treatment for 24 hours, and performing a milling process for about 8 hours, the coercivity, the magnetic flux density, and the density and maximum energy product of the magnet at normal temperature (about 25° C.) and about 150° C. were measured. The results are illustrated in the following Table 4 and FIGS. 7 and 8.

TABLE 4

| Measurement | | | | BHmax |
|---|---|---|---|---|
| temperature (° C.) | Hc (kOe) | Br (kG) | Density (g/cm³) | (MGOe) |
| 25° C. | 3.1 | 6.1 | 8.6 | 7.2 |
| 150° C. | 13.7 | 5.3 | 8.6 | 6.7 |

It is known that when the conventional permanent magnets are subjected to a temperature of more than 150° C., the performance is reduced by 10 to 30% or more. Referring to Table 4 and FIG. 7, the maximum energy product at a high temperature is 6.7 MGOe, which is almost no drop in value compared to the value at a normal temperature, even though the MnBi-based sintered magnet of the present invention is subjected to low-temperature heat treatment (LTP) for only 3 hours during the preparation of the magnetic powder. Thus, it is confirmed that the MnBi-based sintered magnet of the present invention could also be applied to a motor which is driven at high temperature, or instruments which need another magnet.

However, referring to FIG. 8, a performance measurement result according to the change in temperature of the MnBi-based permanent magnet which is the Comparative Example is shown. The maximum energy product value at about 150° C. (about 423 K) was measured as an MGOe of about 4.7. It is again confirmed that the value is about 30% lower than the value of the sintered magnet of the present invention. Also, the MnBi-based sintered magnet of the present invention has excellent high temperature magnetic characteristics.

While preferred embodiments of the present invention have been described in detail, it is to be understood that the scope of the present invention is not limited thereto, and various modifications and variations made by those skilled in the art using basic concepts of the present invention defined in the following claims also fall within the scope of the present invention.

The foregoing embodiments and advantages are merely exemplary and are not to be considered as limiting the present invention. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A method of preparing an MnBi-based magnetic substance, the method comprising:
(a) simultaneously melting a manganese-based material and a bismuth-based material to prepare a mixed melt;
(b) cooling the mixed melt to form a non-magnetic MnBi-based ribbon; and
(c) performing a heat treatment to convert the non-magnetic MnBi-based ribbon into a magnetic MnBi-based ribbon.

2. The method of claim 1, wherein the melting in step (a) is performed at a temperature of 1,200° C. or higher.

3. The method of claim 1, wherein the melting in step (a) is a rapid heating process selected from the group consisting of an induction heating process, an arc-melting process, a mechanochemical process, a sintering process, and a combination thereof.

4. The method of claim 1, wherein cooling in step (b) is a rapid cooling process selected from the group consisting of a rapid solidification process (RSP), an atomizer process, and a combination thereof.

5. The method of claim 4, wherein the rapid solidification process has a wheel speed of 55 to 75 m/s.

6. The method of claim 1, wherein the heat treatment in step (c) is performed at a temperature of 280 to 340° C. and under a pressure of 1 to 5 mPa.

7. The method of claim 1, wherein the heat treatment in step (c) is performed for 2 to 5 hours.

8. The method of claim 1, wherein the heat treatment in step (c) is performed at a temperature of 400° C. or less, wherein the heat treatment at a temperature of 400° C. or less induces diffusion of Mn included in the non-magnetic MnBi-based ribbon.

9. A single phase MnBi-based magnetic substance, comprising:
a Bi crystal average size of 100 nm or less;
an MnBi phase; and
a Bi-rich phase.

10. The single phase MnBi-based magnetic substance of claim 9, wherein the single phase MnBi-based magnetic substance has an atomic ratio of Mn and Bi of 3:7 to 7:3.

11. The single phase MnBi-based magnetic substance of claim 9, wherein the single phase MnBi-based magnetic substance comprises 90% or more of an MnBi low-temperature phase (LTP).

12. A method of preparing an MnBi-based sintered magnet, the method comprising:
(a) pulverizing the MnBi-based magnetic substance of claim 9 to prepare a magnetic powder;
(b) molding the magnetic powder under a magnetic field; and
(c) sintering the molded magnetic powder.

13. The method of claim 12, wherein the pulverization in step (a) is performed by ball milling.

14. The method of claim 13, wherein the ball milling is performed for 2 to 5 hours.

15. The method of claim 13, wherein the ball milling is performed while the ball and the MnBi-based magnetic substance are mixed at a ratio of 1:15 to 1:45.

16. The method of claim 12, wherein the magnetic field in step (b) is applied at an intensity of 1 to 5 T.

17. The method of claim 12, wherein the sintering in step (c) is performed at a temperature of 200 to 300° C. for 3 minutes or less.

18. An MnBi-based sintered magnet, comprising:
an atomic ratio of Mn and Bi of 3:7 to 7:3; and
90% or more of an MnBi low-temperature phase (LTP).

19. The MnBi-based sintered magnet of claim 18, wherein the MnBi-based sintered magnet exhibits heat resistant characteristics having values of coercivity, remnant magnetic flux density, and maximum energy product at 90% or more at 100 to 200° C., compared to values at 15 to 30° C.
